(19) United States
(12) Patent Application Publication
(10) Pub. No.: US 2007/0110855 A1
(43) Pub. Date: May 17, 2007

(54) Cup with Self Contained Utensil for Cryogenically Frozen Dessert Particles

(76) Inventor: Thomas R. Mosey, Mystic, CT (US)

Correspondence Address: Rudolf O. Siegesmund;Gordon & Rees, LLP, Suite 2650, 2100 Ross Avenue, Dallas, TX, 75201, US

(21) Appl. No.: 11/559,800

(22) Filed: Nov. 14, 2006

Related U.S. Application Data
(60) Provisional application No. 60/736,760, filed on Nov. 15, 2005.

(51) Int. Cl. A23B 7/148

(52) U.S. Cl. 426/106

(57) ABSTRACT

A cup having a spoon packaged inside the cup provides an improved method for allowing immediate consumption of cryogenically frozen dessert particles. Spoons are inserted inside the cups when the cryogenically frozen dessert particles are packaged, so that a person purchasing the cup of cryogenically frozen dessert particles can open the package and have a spoon readily available to consume the cryogenically frozen dessert particles.

### RELATED APPLICATIONS

This application claims priority from provisional application 60/736,760, Method of Converting Ice Cream Vending Machines to Vend Cryogenically Frozen Dessert Particles” filed Nov. 15, 2005.

### FIELD OF THE INVENTION

The present invention relates to a cup with self-contained utensil for eating cryogenically frozen dessert particles.

### BACKGROUND OF THE INVENTION

Making novelty ice cream by dripping and/or streaming a liquid ice cream mix into liquid nitrogen is known. For example, U.S. Pat. No. 6,349,549 discloses one method of manufacturing cryogenically frozen particles of ice cream. These cryogenically frozen particles of ice cream present a consumer with novel aspects. The particles initially taste different than regular ice cream because of the small shapes, and the particles can be scooped in a spoon or poured into the mouth.

The novel aspects of cryogenically frozen ice cream make it a popular product at many locations, and such products may be sold in vending machines, or from freezers at supermarkets, convenience stores, ice cream trucks, ice cream vending carts, or kiosks. Moreover, a range of dessert particles can be manufactured by dripping and/or streaming a liquid dessert mix into liquid nitrogen. For example, yogurt, sherberts, sorbets, and water based confections can be manufactured into cryogenically frozen particles using the same techniques that are known for producing cryogenically frozen ice cream particles.

Ice cream vending machines are commercially available for regular ice cream products, such as the ice cream vending machine disclosed in U.S. Pat. No. 5,240,139. The ice cream vending machines have a freezer compartment, a lift device which extracts ice cream containers from the freezer compartment and deposits the ice cream containers in an extraction point. Therefore, a consumer can pay for an ice cream product, and after the machine lifts the ice cream product from the freezer and places the ice cream product at the extraction point, the consumer can grasp the ice cream product to remove it from the vending machine for consumption. However, these ice cream vending machines do not maintain a low enough freezer temperature to keep some ice cream particles from sintering or sticking together.

Ice cream vending machines have been converted to the lower temperatures necessary to keep some cryogenically frozen ice cream particles from sintering, or sticking together, as disclosed by U.S. Pat. No. 6,481,226. As explained further below, it is not always necessary to convert a vending machine to a lower temperature, as some dessert mixes (including ice cream mixes), after being made into cryogenically frozen dessert particles, can be stored at different temperatures in a range from minus forty degrees Fahrenheit to plus ten degrees Fahrenheit, depending primarily on the solid content of the dessert mix.

A known method of serving ice cream from a vending machine is to package the ice cream in cups with flat lids in order to facilitate mechanical retrieval from a freezer compartment and placement at an extraction point. U.S. Pat. No. 5,027,698 discloses an improvement to a vending machine using ice cream packaged in cups with flat lids that removes the lid from the cup, and adds toppings to the ice cream before placing the cup at an extraction point. The '698 further teaches that a spoon can be dispensed along with the opened cup of ice cream.

A problem arises in providing spoons to eat the ice cream. Spoons cannot be attached to the top of the cup or the spoon will interfere with the vacuum lift. If spoons are provided separately, the vacuum lift would have difficulty in lifting a separate spoon, and additional operations would be required. In addition, spoons must be wrapped for hygiene. The vacuum lift would have even greater difficulty in lifting a wrapped spoon since it would be very difficult to attain suction on the wrapped spoon.

In addition to vending machines, cryogenically frozen dessert particles can be sold from special freezers and in some cases cryogenically frozen dessert particles can be sold from freezers designed for regular ice cream. Depending on the composition of the liquid dessert mix, cryogenically frozen dessert particles can maintain their free flowing characteristic in the range of minus forty degrees Fahrenheit to plus ten degrees Fahrenheit. As stated above, the ability of cryogenically frozen dessert particles to maintain their free flowing characteristic when stored at temperatures between minus forty degrees Fahrenheit and plus ten degrees Fahrenheit after freezing depends primarily on the solid content of the dessert mix.

Cryogenically frozen dessert particles can be consumed directly from the cup by pouring the dessert particles directly in the mouth, and this is one of the attractions of such novelty dessert particles. But pouring the particles directly into the mouth can be messy if particles fall onto the consumer's clothing, a table top, or on another persons clothing. Cryogenically frozen dessert particles stored and served at minus forty degrees Fahrenheit can give a burning sensation if poured directly into the mouth at that temperature. Moreover, cryogenically frozen dessert particles spilled onto a walkway can be a safety hazard as they will roll while still maintaining their free flowing characteristic, and then create a slippery surface where they melt. Thus a need exists for a way to consume cryogenically frozen dessert particles directly from the cup in which they are sold, but without the disadvantages of pouring the dessert particles directly into the mouth.

Another problem that can arise in selling cryogenically frozen dessert particles is that young children want to see what the new frozen dessert product looks like. When the containers can be accessed directly in a freezer, such as a freezer in a supermarket or in a convenience store, the children will take a container and open it to see what the novel product looks like, and then place the opened container back in the freezer. The product is then not fit for sale, and this practice creates expense and management problems in distributing and selling the cryogenically frozen dessert particles.

What is needed beyond the prior art is a way to consume cryogenically frozen dessert particles without pouring the particles directly into the mouth. A need further exists for a way to provide cryogenically frozen dessert particles for immediate consumption without regard to where or how the dessert particles are to be sold, such as when sold from a traditional ice cream freezer, a freezer designed for cryogenically frozen dessert particles, or from a vending machine. Moreover, cryogenically frozen dessert particles can be shipped or sold by placing one or more containers of particles in a second container or package along with dry ice so that the dessert particles can be consumed up to twenty four hours after purchase. A need exists for a way to have immediate consumption of the cryogenically frozen dessert particles when the customer is ready to eat the dessert particles. Finally, a need exists for a way to sell cryogenically frozen dessert particles so that a consumer can see what the dessert particles look like without opening the container.

### SUMMARY OF THE INVENTION

A cup having a spoon packaged inside the cup provides an improved method for allowing immediate consumption of cryogenically frozen dessert particles. Spoons are inserted inside the cups when the cryogenically frozen dessert particles are packaged, so that a person purchasing the cup of cryogenically frozen dessert particles can open the package and have a spoon readily available to consume the cryogenically frozen dessert particles. A clear plastic cup allows a consumer to see both the dessert particles and the spoon.

### BRIEF DESCRIPTION OF THE DRAWINGS

FIG. 1 depicts an open vending machine showing the freezer unit;

FIG. 2 depicts a sleeve;

FIG. 3 depicts an open freezer chest with an array of sleeves;

FIG. 4 depicts a vacuum lift and transport device;

FIG. 5A depicts an open ice cream cup with a spoon;

FIG. 5B depicts a closed ice cream cup with a flat lid; and

FIG. 6 depicts an ice cream vending machine.

### DETAILED DESCRIPTION OF THE PREFERRED EMBODIMENT

As used herein, the term “cryogenically frozen dessert particles” shall mean dessert particles formed by dripping and/or streaming a liquid ice cream mix into liquid nitrogen, and shall further include dessert particles formed by dripping and/or streaming a liquid yogurt mix, a liquid sherbert mix, a liquid sorbet mix, or a liquid water based confection mix into liquid nitrogen.

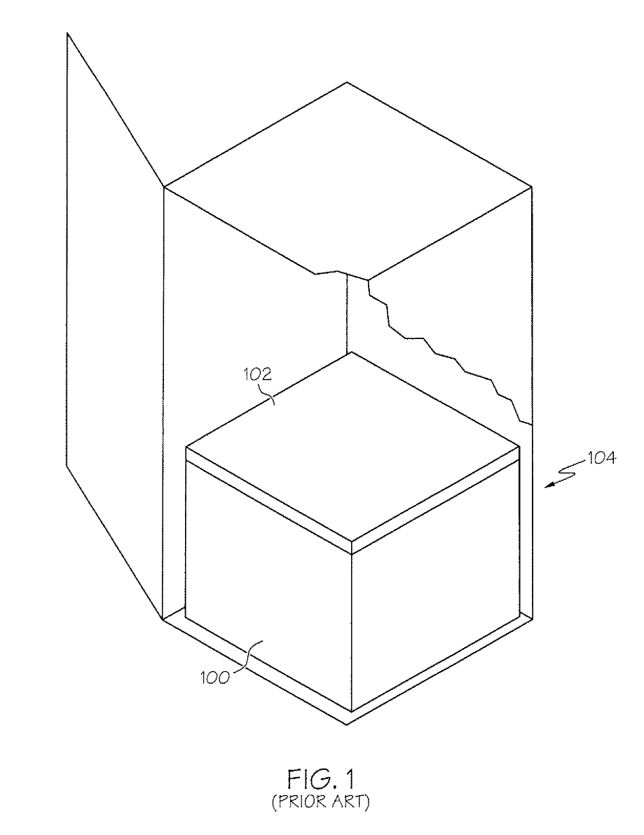

FIG. 1 depicts vending machine 104 having freezer unit 100 with lid 102 hingedly attached to freezer unit 100.

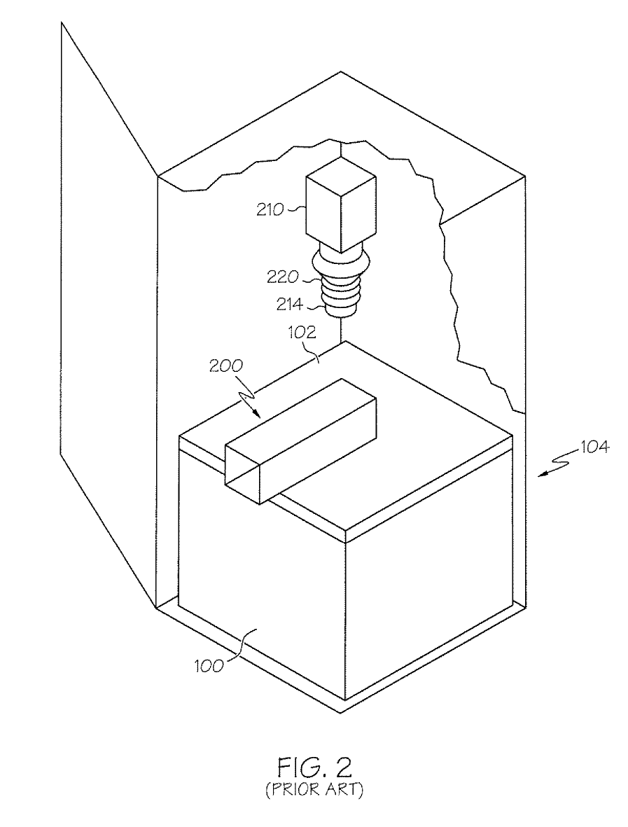

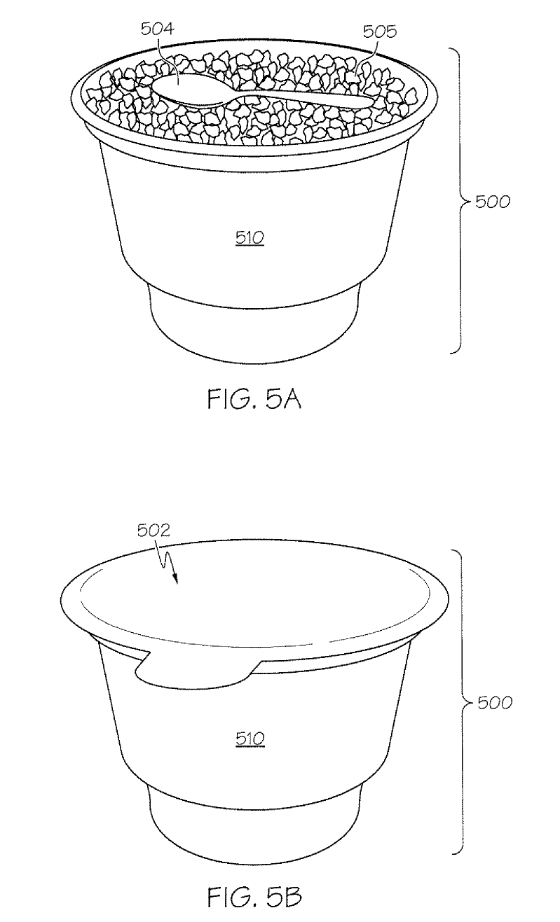

FIG. 2 depicts vacuum lift device 210 with vacuum lift extension device 220. Sleeve 200 is shown resting on lid 102. Sleeve 200 is generally square in cross section and has a length approximately equal to the depth of freezer unit 100. Sleeve 200 dimensions are sufficient to allow insertion of ice cream cups such as ice cream cup 500 (see FIG. 5) so that ice cream cups can be stacked one on top of the other within sleeve 200.

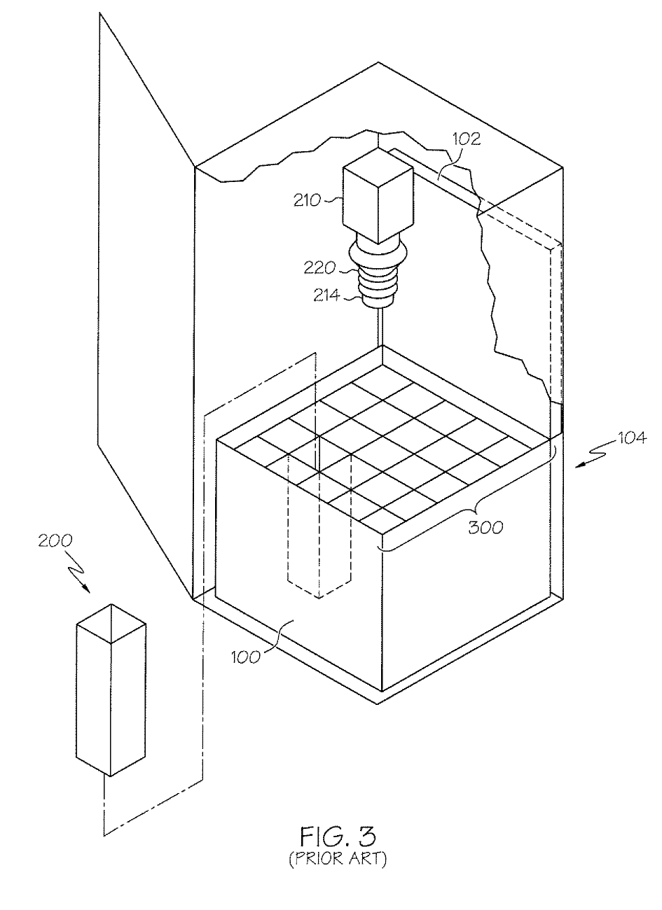

FIG. 3 depicts freezer 100 with lid 102 raised by a lifting arm (not shown). Array 300 of sleeves 200 is disposed within freezer 100 so that freezer 100 is divided into an array of sleeves each capable of holding approximately 20 ice cream cups. Cups such as cup 500 are disposed within sleeve 200 so that a flat top surface of lid 502 of cup 500 is horizontal and presented for engagement with vacuum nozzle 214. Vacuum lift extension 220 can be lowered to contact the flat surface of cup 500 to adhere to lid 502 of cup 500 so that cup 500 can be lifted out of sleeve 200 and moved to a location from which it can be extracted by a purchaser.

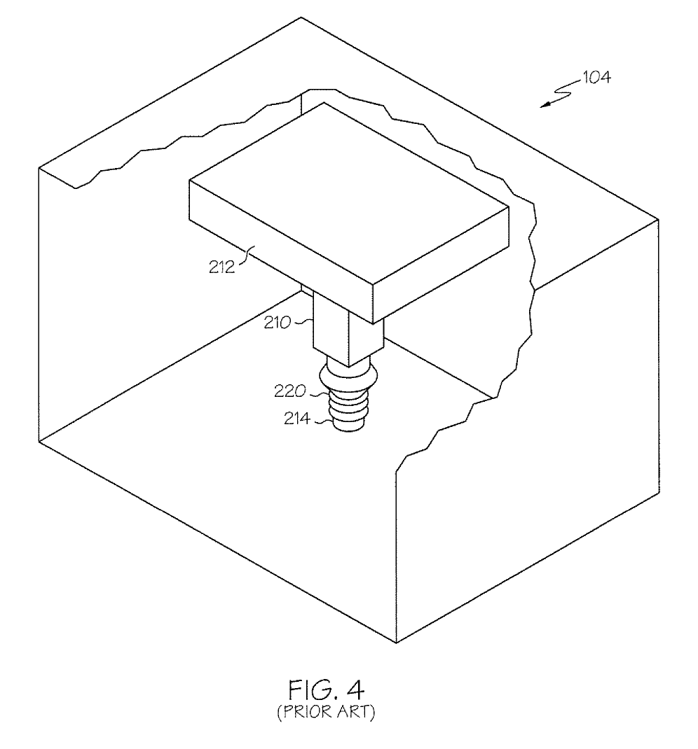

FIG. 4 depicts vacuum lift device 210 and transport device 212 within shell of vending machine 104. Vacuum lift extension device 220 extends below vacuum lift device 210, having vacuum nozzle 214 at the lower end of vacuum lift device 210.

FIG. 5A depicts cup 500 having spoon 504 placed on top of cryogenically frozen dessert particles 505 inside container 510. Unlike traditional frozen ice cream, cryogenically frozen dessert particles kept to a proper temperature will not melt or sinter. Therefore, spoon 504 will not adhere to cryogenically frozen dessert particles 505 and spoon 504 can be removed from cryogenically frozen dessert particles 505 without becoming messy and sticky. Spoon 504 remains clean while ice cream cup 500 is kept at a temperature determined primarily by solid content of the dessert mix so that the cryogenically frozen dessert particles do not begin to sinter or melt in cup 500 until a customer opens lid 502 and removes spoon 504, provided that the foregoing actions are taken by the customer within several minutes after removing cup 500 from the freezer. Normally, spoons cannot be packed inside a container of regular ice cream because the ice cream would adhere to the spoon. The lid of traditional ice cream containers normally contacts the ice cream as part of the bonding of the lid to the ice cream container. However, the unique characteristics of cryogenically frozen ice cream particles allows placement of a spoon inside the ice cream cup.

FIG. 5B depicts cup 500 having flat lid 502 affixed to container 510 to facilitate acquisition by a vacuum lift device. Lid 502 is affixed to container 510 after cryogenically frozen dessert particles 505 and spoon 504 are placed inside container 510. Preferably, lid 502 is affixed to container 510 by heat sealing. Persons skilled in the art are aware of various other methods for affixing lid 502 to container 510 and heat sealing is provided only by way of example and not by way of limitation. Any known suitable means can be used to affix lid 502 to container 510. Lid 502 is affixed to container 510, and lid 502 and container 510 are dimensioned so that lid 502 will provide a flat circular surface area that exceeds the circumference of container 510 so that vacuum nozzle 214 (see FIG. 4) is provided with a target area larger than the circumference of container 510 to reduce vending errors. Persons skilled in the art will be aware that the shape of the cup may be round, rectangular, square, or may be of other shapes, and that the shape will be dictated by the amount of dessert particles to be sold in the cup, the manner in which the cup will be stored, and the aesthetic preferences of the manufacturer of the cryogenically frozen dessert particles. Moreover, the cup may be made of clear plastic, and the lid may also be made of clear plastic allowing a consumer to see both the cryogenically frozen dessert particles and the spoon inside the cup.

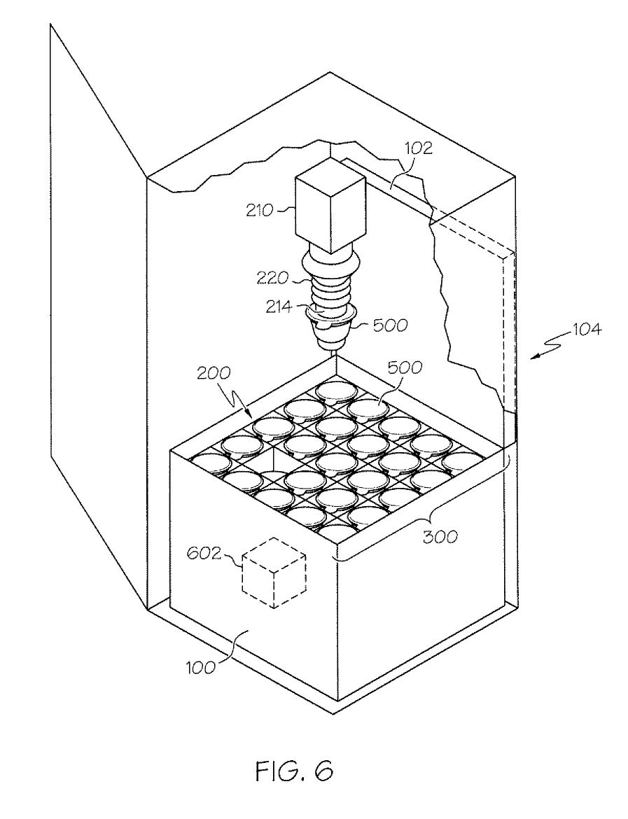

FIG. 6 depicts freezer unit 100 within shell of vending machine 104. Lid 102 is in open position and vacuum lift device 210 with vacuum lift device extension 220 and vacuum nozzle 214 is shown extracting cup 500 from sleeve 200 of array 300. Cup 500 may be placed in extraction point 602 so that a consumer may grasp and remove cup 500.

In an alternate embodiment, cup 500 may be packaged without spoon 504 being placed on top of the cryogenically frozen dessert particles, and spoon 504 may be placed on top of lid 502, and a second lid (not shown) may be affixed to cup 500 so that the second lid covers the spoon and lid 502.

It will be understood from the foregoing description that various modifications and changes may be made in the preferred embodiment of the present invention without departing from its true spirit. Specifically, one skilled in the art can provide cryogenically frozen dessert particles for sale and/or consumption by selling from freezers designed to hold the product at lower temperatures than regular ice cream, from freezers designed to hold regular ice cream, and in some cases, from freezers with temperatures as high as plus ten degrees Fahrenheit. A vending machine has been presented as one example, since a vending machine is the most complex means of selling cryogenically frozen dessert particles. It is intended that this description is for purposes of illustration only and should not be construed in a limiting sense. The scope of this invention should be limited only by the language of the following claims.

What is claimed:

1. A apparatus for packaging a plurality of cryogenically frozen dessert particles comprising:
a container, a spoon, and a lid;
wherein the plurality of cryogenically frozen dessert particles are located in the container, the spoon is located on top of the cryogenically frozen dessert particles, and the lid is sealingly engaged over the container so that a user can remove the lid and have the spoon available for consumption of the cryogenically frozen dessert particles.

2. The apparatus of claim 1 wherein the container is a clear plastic.

3. The apparatus of claim 2 wherein both the spoon and the cryogenically frozen dessert particles can be seen through the clear plastic.

4. An apparatus comprising:
a cup containing a plurality of cryogenically frozen dessert particles;
a spoon; and
a cover;
wherein the cryogenically frozen dessert particles are located in the cup, the spoon is located on top of the cryogenically frozen dessert particles, and the cover is sealingly engaged to the cup so that the spoon and the plurality of cryogenically frozen dessert particles are enclosed by the cup and the cover.

5. The apparatus of claim 4 wherein the cup is a clear plastic.

6. The apparatus of claim 5 wherein both the spoon and the cryogenically frozen dessert particles can be seen through the clear plastic.

7. An apparatus comprising:
a cup containing a plurality of cryogenically frozen dessert particles;
a spoon;
a first cover; and
a second cover;
wherein the first cover is sealing engaged to the cup after the cup is filled with cryogenically frozen dessert particles, the spoon is located on top of the first cover, and a second cover is affixed to the cup enclosing the first cover and the spoon.

8. The apparatus of claim 7 wherein the cup is a clear plastic.

9. The apparatus of claim 8 wherein the cryogenically frozen dessert particles can be seen through the clear plastic.

10. The apparatus of claim 7 wherein the second cover is a clear plastic and the spoon can be seen through the clear plastic.
